(19) United States
(12) Patent Application Publication
(10) Pub. No.: US 2008/0227013 A1
(43) Pub. Date: Sep. 18, 2008

(54) TONER AND PROCESS CARTRIDGE

(76) Inventors: Takuya KADOTA, Kobe-shi (JP); Chiyoshi Nozaki, Otsu-shi (JP); Katsunori Kurose, Takarazuka-shi (JP); Tsuyoshi Nozaki, Ikeda-shi (JP); Hiroyuki Murakami, Toyonaka-shi (JP); Mitsuyo Matsumoto, Ibaraki-shi (JP); Yoshimichi Ishikawa, Itami-shi (JP); Atsushi Yamamoto, Kawanishi-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/035,892

(22) Filed: Feb. 22, 2008

(30) Foreign Application Priority Data
Mar. 15, 2007 (JP) 2007-066101

(51) Int. Cl. G03G 9/097

(52) U.S. Cl. 430/108.15

(57) ABSTRACT

A toner including a fluorine-containing compound partially comprising a quaternary ammonium group at the surface thereof, which is prepared by a method, including dispersing or emulsifying an oil phase including toner constituents including a pigment, and at least one member selected from the group consisting of modified layered inorganic minerals partially including a quaternary alkylammonium group and toner constituent precursors in an aqueous medium, wherein the toner constituents includes the modified layered inorganic mineral in an amount of from 0.05 to 2% by weight and the toner includes a fluorine atom in an amount of from 0.02 to 0.075 K cps when measured with a fluorescent X-ray.

### BACKGROUND OF THE INVENTION

1. Field of the Invention

The present invention relates to a toner and a process cartridge for use in electrophotographic image forming apparatuses.

2. Discussion of the Background

Recently, printers are having higher performances, and particularly full-color printers are having higher speeds and longer lives, and producing higher quality images. Particularly, the charge buildability of a toner and its stability weigh heavily in higher speeds of printers. As improvements thereof, a number of studies on charge controlling agents are made.

Any of WO01/040878, WO2004/019137, WO2004/019138 and Japanese published unexamined patent application No. 2003-202708 discloses a layered compound used for charge control. However, any of them has insufficient charge buildability when used in a one-component developer. A right amount thereof for imparting sufficient charge buildability to a toner adversely affects the environmental stability of the toner because the layered compound originally has hydrophilicity.

Japanese published unexamined patent application No. 1-23959 discloses a method of locally presenting a fluorine-containing compound on the surface of a toner to reducing adherence between the toner and a photoreceptor, wherein a suspension polymerization method of preparing a toner locally presents a so-called a fluorine-containing compound including a hydrophilic radical having a interfacial activity power on the surface thereof. However, when an amount of the fluorine-containing compound present on the surface of a toner is preferably controlled to control the adherence, it is possible that the hydrophilic radical of the fluorine-containing compound adversely affects the toner. Further, the fluorine-containing compound is not fully bonded with the toner and the reduction thereof due to long-term use is inevitable. Therefore, even a fluorine-containing charge controlling agent is difficult to maintain the effect for a long time, i.e., the chargeability of a toner is not fully controlled.

Japanese published unexamined patent application No. 5-53367 discloses a method of presenting a polymer or a copolymer of fluorinated alkylacrylate or fluorinated alkylmethacrylate in a surface layer of a toner to impart chargeability thereto.

However, since this method locally presents the fluorine-containing resin on the surface of a toner, a process wherein a toner separately prepared is coated in a solvent including the fluorine-containing resin is needed. This not only increase the cost, but also a fluorine-containing resin soluble in a solvent such as alcohol cannot fully control the chargeability of a toner.

Because of these reasons, a need exists for a toner having good chargeability, environmental stability and durability, and producing quality images.

### SUMMARY OF THE INVENTION

Accordingly, an object of the present invention is to provide a toner having good chargeability, environmental stability and durability, and producing quality images.

Another object of the present invention is to provide a process cartridge using the toner.

These objects and other objects of the present invention, either individually or collectively, have been satisfied by the discovery of a toner, comprising a fluorine-containing compound partially comprising a quaternary ammonium group at the surface thereof, which is prepared by a method, comprising:

dispersing or emulsifying an oil phase comprising toner constituents comprising a pigment, and at least one member selected from the group consisting of modified layered inorganic minerals partially comprising a quaternary alkylammonium group and toner constituent precursors in an aqueous medium, wherein the toner constituents comprises the modified layered inorganic mineral in an amount of from 0.05 to 2% by weight and the toner comprises a fluorine atom in an amount of from 0.02 to 0.075 K cps when measured with a fluorescent X-ray.

These and other objects, features and advantages of the present invention will become apparent upon consideration of the following description of the preferred embodiments of the present invention (taken in conjunction with the accompanying drawing.

### BRIEF DESCRIPTION OF THE DRAWING

Various other objects, features and attendant advantages of the present invention will be more fully appreciated as the same becomes better understood from the detailed description when considered in connection with the accompanying drawing in which like reference characters designate like corresponding parts throughout and wherein:

FIGURE is a schematic view illustrating an embodiment of the process cartridge of the present invention.

### DETAILED DESCRIPTION OF THE INVENTION

The present invention provides a toner having good chargeability, environmental stability and durability, and producing quality images. More particularly, the present invention relates to a toner, comprising a fluorine-containing compound partially comprising a quaternary ammonium group at the surface thereof, which is prepared by a method, comprising:

dispersing or emulsifying an oil phase comprising toner constituents comprising a pigment, and at least one member selected from the group consisting of modified layered inorganic minerals partially comprising a quaternary alkylammonium group and toner constituent precursors in an aqueous medium,

wherein the toner constituents comprises the modified layered inorganic mineral in an amount of from 0.05 to 2% by weight and the toner comprises a fluorine atom in an amount of from 0.02 to 0.075 K cps when measured with a fluorescent X-ray.

The oil phase includes a pigment, at least one of a modified layered inorganic mineral and a prepolymer and/or a monomer and may include other toner constituents such as a release agent.

In the present invention, the toner constituents mean what is finally included in a toner.

The toner constituents precursor in the present invention is a precursor of toner constituents, and specifically a prepolymer or a monomer.

Since the layered inorganic mineral conventionally used for charging a toner has hydrophilicity, the resultant toner can maintain environmental stability when including an adequate amount thereof. However, an adequate amount of the modified layered inorganic mineral included in a toner can increase an absolute value of charge quantity of the toner, but cannot fully contribute to charge buildability of a toner.

Therefore, the toner of the present invention includes the above-mentioned modified layered inorganic mineral and further includes a fluorine-containing compound (fluorine-containing charge controlling agent) partially comprising a quaternary ammonium group to cover the shortcomings of the conventional layered inorganic mineral. An amount of the fluorine-containing charge controlling agent at the surface of a toner is specified to provide a toner having good charge buildability and smear resistance. Further, the durability and environmental stability of the fluorine-containing compound having insufficient durability even though locally present at the surface of a toner are improved, and the resultant toner has good charge buildability, environmental stability and charge stability.

Although detailed mechanism bringing the above-mentioned effect is not clarified, a synergetic effect such as an intercalation between the modified layered inorganic mineral partially comprising a quaternary alkylammonium group and the quaternary ammonium group of the fluorine-containing charge controlling agent at the surface of a toner is thought to be capable of maintaining the durability and environmental stability thereof.

In addition, the modified layered inorganic mineral has moderate hydrophilicity although being hydrophobic, and therefore the modified layered inorganic mineral is likely to be oriented to an aqueous phase in an oil drop when dispersed/emulsified. Namely, the modified layered inorganic mineral go close to the surface of a droplet and is present close to the surface of a toner. Therefore, the resultant toner efficiently has chargeability with an amount thereof less than that for a toner prepared by pulverization. Further, it is thought that the synergetic effect due to an intercalation with the fluorine-containing charge controlling agent present at the surface of a toner can be maintained.

First, the modified layered inorganic mineral used as a charge controlling agent in the present invention will be explained.

The layered inorganic mineral is an inorganic mineral including overlapped layers having a thickness of some nm respectively. Modifying with an organic material ion means introducing an organic material ion into an ion present between the layers, which is called an intercalation in a broad sense. The layered inorganic minerals include a smectite group such as montmorillonite and saponite; a kaolin group such as kaolinite; magadiite; and kanemite. The modified layered inorganic mineral has high hydrophilicity because of its modified layered structure. Therefore, when the layered inorganic mineral is dispersed without being modified in an aqueous medium to granulate a toner, the layered inorganic mineral passes into the aqueous medium and cannot be dispersed in a toner. The layered inorganic mineral becomes more hydrophobic when modified and is easily dispersed and miniaturized in a toner when granulated to fully perform charge controllability. The toner constituents preferably include the modified layered inorganic mineral in an amount of from 0.05 to 2% by weight. When less than 0.05% by weight, the resultant toner does not have sufficient chargeability. When greater than 2% by weight, the hydrophilicity the layered inorganic mineral originally has causes deterioration of environmental stability and chargeability in particular at high temperature and high humidity.

Organic cation modifiers modifying at least a part of ions the layered inorganic mineral has are preferably quaternary alkylammonium salts. Specific examples thereof include trimethylstearylammonium, dimethylstearylbenzylammonium, dimethyloctadecylammonium, oleylbis(2-hydroxylethyl)methylammonium, etc.

Specific examples of the (modified)layered inorganic mineral partially modified with an organic material ion include montmorillonite, bentonite, hectolite, attapulgite, sepiolite, their mixtures, etc. Particularly, the organic-modified montmorillonite or bentonite is preferably used because they do not influence upon the resultant toner properties, the viscosity thereof can easily be controlled and a small content thereof works.

Specific examples of marketed products of the layered inorganic mineral partially modified with an organic material cation include Quartanium 18 Bentonite such as Bentone 3, Bentone 38 and Bentone 38V from Rheox, Inc., Tixogel VP from United Catalyst, Inc., Clayton 34, Clayton 40 and Clayton XL from Southern Clay Products, Inc.; Stearalkonium Bentonite such as Bentone 27 from Rheox, Inc., Tixogel LG from United Catalyst, Inc., Clayton AF and Clayton APA from Southern Clay Products, Inc.; and Quartanium 18/Benzalkonium Bentonite such as Clayton HT and Clayton PS from Southern Clay Products, Inc. Particularly, Clayton AF and Clayton APA are preferably used.

The modified layered inorganic mineral having moderate hydrophobicity is likely to be locally present at the surface of a droplet to improve chargeability of the resultant toner.

Specific examples of the cationic surfactant having a fluoroalkyl group preferably used include primary, secondary and tertiary aliphatic amines having a fluoroalkyl group, aliphatic quaternary ammonium salts such as erfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SURFLONS-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos Co., Ltd.); etc.

A fluorine-containing quaternary ammonium salt compound having the following formula (1) can prepare a stable developer with less charge quantity variation when the environment changes.

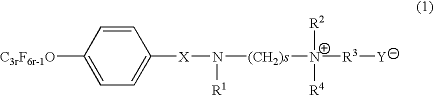

wherein X represents −SO₂— or —CO—; R¹ to R⁴ independently represent a hydrogen atom, a lower alkyl group having 1 to 10 carbon atoms or an aryl group; Y represents I or Br; and r and s independently represents an integer of from 1 to 20.

The toner of the present invention preferably includes the fluorine-containing compound in an amount of from 0.05 to 0.5% by weight. When less than 0.05% by weight, the resultant toner does not have good chargeability. When greater than 5% by weight, the resultant toner has poor fixability.

Binder resins for use in the present invention are not particularly limited, and styrene-acrylic resins and polyester resins are preferably used. In addition, the binder resin may be cross-linked or uncross-linked.

The uncross-linked resin is a resin cross-linked by 0 to 0.2% or less than 0.1%. The cross-linked resin is cross-linked by about 0.3 to 20%. The cross-linked component is a THF-insoluble component.

The uncross-linked resin is substantially not cross-linked, and may have a branched chain or plural block components. The uncross-linked resin is preferably an unmodified polyester resin. The cross-linked resin is preferably a modified polyester resin.

In the present invention, polyester resins are preferably used, and any of them or any combination of them can be used.

The polyester resins include polycondensated products between polyols (1) and polycarboxylic acids (2).

Specific examples of the polyols (1) include alkylene glycol such as ethylene glycol, 1,2-propylene glycol, 1,3-propylene glycol, 1,4-butanediol, and 1,6-hexanediol; alkylene ether glycol such as diethylene glycol, triethylene glycol, dipropylene glycol, polyethylene glycol, polypropylene glycol and polytetramethylene ether glycol; alicyclic diol such as 1,4-cyclohexanedimethanol and hydrogenated bisphenol A; bisphenols such as bisphenol A, bisphenol F and bisphenol S; 4,4-dihydroxybiphenyls such as 3,3′-difluoro-4,4-dihydroxybiphenyl; bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (tetrafluorobisphenol A), and 2,2-bis(3-hydroxyphenyl)-1,1,1,3,3,3-hexafluoropropane; bis(4-hydroxyphenyl)ethers such as a bis(3-fluoro-4-hydroxyphenyl)ether; adducts of the above-mentioned alicyclic diol with an alkylene oxide such as ethylene oxide, propylene oxide and butylene oxide; adducts of the above-mentioned bisphenol with an alkylene oxide such as ethylene oxide, propylene oxide and butylene oxide, etc.

In particular, alkylene glycol having 2 to 12 carbon atoms and adducts of bisphenol with an alkylene oxide are preferably used, and a mixture thereof is more preferably used.

Further, multivalent aliphatic alcohol having 3 to 8 or more valences such as glycerin, trimethylolethane, trimethylolpropane, pentaerythritol and sorbitol; phenol having 3 or more valences such as trisphenol PA, phenolnovolak, cresolnovolak; and adducts of the above-mentioned polyphenol having 3 or more valences with an alkylene oxide can also be used.

These polyols can be used alone or in combination, and are not limited thereto.

Specific examples of the polycarboxylic acids (2) include alkylene dicarboxylic acids such as a succinic acid, an adipic acid and a sebacic acid; alkenylene dicarboxylic acids such as a maleic acid and a fumaric acid; and aromatic dicarboxylic acids such as a phthalic acid, an isophthalic acid, a terephthalic acid and a naphthalene dicarboxylic acid, a 3-fluoroisophthalic acid, a 2-fluoroisophthalic acid, a 2-fluoroterephthalic acid, a 2,4,5,6-tetrafluoroisophthalic acid, a 5-trifluoromethylisophthalic acid, 2,2-bis(4-carboxyphenyl)hexafluoropropane, 2,2-bis(3-carboxyphenyl)hexafluoropropane, a 2,2′-bis(trifluoromethyl)-4,4′-biphenyl dicarboxylic acid, a 3,3′-bis(trifluoromethyl)-4,4′-biphenyldicarboxylic acid, a 2,2′-bis(trifluoromethyl)-3,3′-biphenyldicarboxylic acid, a hexafluoroisopropylidenediphthalic acid anhydride, etc.

In particular, alkenylene dicarboxylic acid having 4 to 20 carbon atoms and aromatic dicarboxylic acid having 8 to 20 carbon atoms are preferably used. Specific examples of the polycarboxylic acid having 3 or more valences include aromatic polycarboxylic acids having 9 to 20 carbon atoms such as a trimellitic acid and a pyromellitic acid. In addition, the polycarboxylic acid can be formed from a reaction between the polyol (1) and the above-mentioned acids anhydride or lower alkyl ester such as methyl ester, ethyl ester and isopropyl ester.

These polycarboxylic acids can be used alone or in combination, and are not limited thereto.

The polyol and polycarboxylic acid are mixed such that an equivalent ratio ([OH]/[COOH]) between a hydroxyl group [OH] and a carboxylic group [COOH] is typically from 2/1 to 1/1, preferably from 1.5/1 to 1/1, and more preferably from 1.3/1 to 1.02/1.

The polyester resin preferably has a peak molecular weight of from 1,000 to 30,000, preferably from 1,500 to 10,000, and more preferably from 2,000 to 8,000. When less than 1,000, the heat-resistant preservability of the resultant toner deteriorates. When greater than 30,000, the low-temperature fixability thereof deteriorates.

As a cross-linked resin included in the toner of the present invention, a modified polyester resin having a urethane group and/or a urea group can be used to control viscoelasticity of the toner for the purpose of inhibiting offset. The toner preferably includes the cross-linked resin in an amount of from 3 to 30% by weight, more preferably from 5 to 20% by weight, and furthermore preferably from 7 to 20% by weight. When greater than 30% by weight, the low-temperature fixability occasionally deteriorates. When less than 3% by weight, the hot offset resistance occasionally deteriorates. The modified polyester resin having a urethane group and/or a urea group may directly be mixed with a binder resin, however, in terms of productivity, it is more preferable that a comparatively a low-molecular-weight modified polyester resin (hereinafter referred to as a prepolymer) and amines reactable therewith are elongated and/or cross-linked with each other while or after the toner is granulated to form the modified polyester resin having a urethane group and/or a urea group. This facilitates including comparatively a polymeric modified polyester resin at the core of the toner to control the viscoelasticity thereof.

Specific examples of the prepolymer having an isocyanate group include a polymer formed from a reaction between polyester having an active hydrogen atom formed by polycondensation between the polyol (1) and the polycarboxylic acid (2), and polyisocyanate (3). Specific examples of the groups including the active hydrogen include a hydroxyl group (an alcoholic hydroxyl group and a phenolic hydroxyl group), an amino group, a carboxyl group, a mercapto group, etc. In particular, the alcoholic hydroxyl group is preferably used.

Specific examples of the polyisocyanate (3) include aliphatic polyisocyanate such as tetramethylenediisocyanate, hexamethylenediisocyanate and 2,6-diisocyanatemethylcaproate; alicyclic polyisocyanate such as isophoronediisocyanate and cyclohexylmethanediisocyanate; aromatic diisocyanate such as tolylenedisocyanate and diphenylmethanediisocyanate; aroma aliphatic diisocyanate such as α,α,α′,α′-tetramethylxylylenediisocyanate; isocyanurate; the above-mentioned polyisocyanate blocked with phenol derivatives, oxime and caprolactam; and their combinations.

The polyisocyanate (3) is mixed with polyester such that an equivalent ratio ([NCO]/[OH]) between an isocyanate group [NCO] and polyester having a hydroxyl group [OH] is typically from 5/1 to 1/1, preferably from 4/1 to 1.2/1 and more preferably from 2.5/1 to 1.5/1. When [NCO]/[OH] is greater than 5, low temperature fixability of the resultant toner deteriorates. When [NCO] has a molar ratio less than 1, a urea content in ester of the modified polyester decreases and hot offset resistance of the resultant toner deteriorates. The content of the constitutional component of a polyisocyanate in the polyester prepolymer (A) having a polyisocyanate group at its end portion is from 0.5 to 40% by weight, preferably from 1 to 30% by weight and more preferably from 2 to 20% by weight. When the content is less than 0.5% by weight, hot offset resistance of the resultant toner deteriorates, and in addition, the heat resistance and low temperature fixability of the toner also deteriorate. In contrast, when the content is greater than 40% by weight, low temperature fixability of the resultant toner deteriorates.

The number of the isocyanate groups included in a molecule of the polyester prepolymer (A) is at least 1, preferably from 1.5 to 3 on average, and more preferably from 1.8 to 2.5 on average. When the number of the isocyanate group is less than 1 per 1 molecule, the molecular weight of the modified polyester after elongated and/or cross-linked decreases and hot offset resistance of the resultant toner deteriorates.

Specific examples of amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific examples of the polyamines (B2) having three or more amino groups include diethylene triamine, triethylene tetramine.

Specific examples of the amino alcohols (B3) include ethanol amine and hydroxyethyl aniline.

Specific examples of the amino mercaptan (B4) include aminoethyl mercaptan and aminopropyl mercaptan. Specific examples of the amino acids include amino propionic acid and amino caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc.

The molecular weight of the modified polyester can optionally be controlled using an elongation anticatalyst, if desired. Specific examples of the elongation anticatalyst include monoamines such as diethyle amine, dibutyl amine, butyl amine and lauryl amine, and blocked amines, i.e., ketimine compounds prepared by blocking the monoamines mentioned above.

The mixing ratio (i.e., a ratio [NCO]/[NHx]) of the content of the prepolymer (A) having an isocyanate group to the amines (B) is from 1/2 to 2/1, preferably from 1.5/1 to 1/1.5 and more preferably from 1.2/1 to 1/1.2. When the mixing ratio is greater than 2 or less than 1/2, molecular weight of a urea-modified polyester (i) decreases, resulting in deterioration of hot offset resistance of the resultant toner.

Specific examples of colorants for use in the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENEBLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination. The toner particles preferably include the colorant in an amount of from 1 to 15% by weight, and more preferably from 3 to 10% by weight. The colorant for use in the present invention can be used as a masterbatch pigment when combined with a resin.

Specific examples of the resin for use in the masterbatch pigment or for use in combination with masterbatch pigment include the modified and unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butylmethacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

The masterbatch for use in the toner of the present invention is typically prepared by mixing and kneading a resin and a colorant upon application of high shear stress thereto. In this case, an organic solvent can be used to heighten the interaction of the colorant with the resin. In addition, flushing methods in which an aqueous paste including a colorant is mixed with a resin solution of an organic solvent to transfer the colorant to the resin solution and then the aqueous liquid and organic solvent are separated and removed can be preferably used because the resultant wet cake of the colorant can be used as it is. Of course, a dry powder which is prepared by drying the wet cake can also be used as a colorant. In this case, a three-roll mill is preferably used for kneading the mixture upon application of high shear stress.

Known release agents can be used in the present invention, and specific examples thereof include polyolefin waxes such as polyethylene wax and polypropylene wax; long chain carbon hydrides such as paraffin wax and sasol wax; and waxes including carbonyl groups. Specific examples of the waxes including carbonyl groups include polyesteralkanate such as carnauba wax, montan wax, trimethylolpropanetribehenate, pentaelislitholtetrabehenate, pentaelislitholdiacetatedibehenate, glycerinetribehenate and 1,18-octadecanedioldistearate; polyalkanolesters such as tristearyltrimellitate and distearylmaleate; polyamidealkanate such as ethylenediaminebehenylamide; polyalkylamide such as tristearylamidetrimellitate; and dialkylketone such as distearylketone. Among these waxes including a carbonyl group, polyesteralkanate is preferably used.

The toner of the present invention includes the wax in an amount of from 5 to 15% by weight based on total weight of resins. When less than 5% by weight, the releasability and offset resistance of the resultant toner occasionally deteriorate. When greater than 15% by weight, the wax melts at a low temperature and is likely to receive influences of a heat energy and a mechanical energy. The wax exudes from inside the toner when stirred in an image developer and adheres to a regulation member or an electrostatic latent image bearer, resulting in image noise. In addition, the wax preferably has an endothermic peak of from 65 to 115° C. when heated when measured with a differential scanning calorimeter (DSC). When less than 65° C., the fluidity of the resultant toner tends to deteriorate. When greater than 115° C., the fixability thereof tends to deteriorate.

The toner of the present invention may optionally include a charge controlling agent. Specific examples of the charge controlling agent include any known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc. Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc.

As an external additive to subsidize the fluidity, developability and chargeability of the toner of the present invention, a particulate inorganic material is preferably used. The particulate inorganic material preferably has an average primary particle diameter of from 5 nm to 2 μm, and more preferably from 5 to 500 nm. In addition, the particulate inorganic material preferably has a specific surface area of from 20 to 500 m²/g when measured by a BET method. The toner preferably includes the particulate inorganic material in an amount of from 0.01 to 5% by weight, and more preferably from 0.01 to 2.0% by weight. Specific examples of the particulate inorganic material include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, rediron oxide, antimony trioxide, magnesium oxide, zirconium oxide, barium sulfate, barium carbonate, calcium carbonate, silicon carbide, silicon nitride, etc.

Specific examples of the other external additives include polystyrene formed by a soap-free emulsion polymerization, a suspension polymerization or a dispersion polymerization; ester methacrylate or ester acrylate copolymer; silicone; benzoguanamine; polycondensated products such as nylon; polymeric particulate materials formed of thermosetting resins; etc.

A fluidity improver for use in the present invention is a surface treatment agent to increase the hydrophobicity of a toner to prevent deterioration of fluidity and chargeability thereof even in an environment of high humidity. Specific examples thereof include a silane coupling agent, a sililating agents a silane coupling agent having an alkyl fluoride group, an organic titanate coupling agent, an aluminium coupling agent a silicone oil and a modified silicone oil.

A cleanability improver for use in the present invention is added to remove a developer remaining on a photoreceptor and a first transfer medium after transferred. Specific examples of the cleanability improver include fatty acid metallic salts such as zinc stearate, calcium stearate and stearic acid; and polymer particles prepared by a soap-free emulsifying polymerization method such as polymethylmethacrylate particles and polystyrene particles. The polymer particles comparatively have a narrow particle diameter distribution and preferably have a volume-average particle diameter of from 0.01 to 1 μm.

The disperser is not particularly limited, and low-speed shearing dispersers, high-speed shearing dispersers, friction dispersers, high-pressure jet dispersers, ultrasonic dispersers, etc. can be used. Among these methods, high-speed shearing dispersers are preferably used because particles having a particle diameter of from 2 to 20 μm can be easily prepared. When a high-speed shearing disperser is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 150° C. (under pressure), and preferably from 40 to 98° C.

A parent toner particles can be formed by known methods. Specific examples thereof include methods such as a suspension polymerization method, an emulsion polymerization agglutination method and a solution suspension method; and a method of forming parent toner particles while producing an adhesive base material. Among these methods, the method of forming parent toner particles while producing an adhesive base material is preferably used. The adhesive base material has adhesiveness to a recording medium such as a paper.

The method of forming parent toner particles while producing an adhesive base material includes reacting a compound including a group having an active hydrogen with a polymer reactable therewith un an aqueous medium. In addition, the adhesive base material may optionally include a binder resin besides these.

The parent toner particles preferably includes a colorant, and may optionally include a release agent, a charge controlling agent and other components.

The adhesive base material preferably has a peak molecular weight not less than 3,000, more preferably from 5,000 to 1,000,000, and much more preferably from 7,000 to 500,000. When less than 3,000, the hot offset resistance of the resultant toner occasionally deteriorates.

The non-magnetic one-component developer of the present invention is preferably prepared by the following method, but is not limited thereto.

The method of preparing the non-magnetic one-component developer of the present invention includes dissolving or dispersing at least a binder resin having a polyester skeleton including an aromatic group, a highly-polar resin, a colorant and a release agent in an organic solvent to prepare a solution or a dispersion; and dispersing the solution or dispersion in an aqueous medium.

Specifically, the method is as follows.

The organic solvent in which the binder resin having a polyester skeleton including an aromatic group, highly-polar resin, colorant and release agent are dissolved or dispersed is preferably a solvent having a Hansen solubility parameter not greater than 19.5 disclosed in Section VII of Volume 2 of the 4^{th} edition of “POLYMER HANDBOOK” published from WILEY-INTERSCIENCE, and preferably a volatile solvent having a boiling point less than 100° C. because the solvent can easily be removed afterwards. Specific examples of such a solvent include toluene, xylene, benzene, carbon tetrachloride, methylenechloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These solvents can be used alone or in combination. Among these solvents, aromatic solvents such as toluene and xylene; and halogenated hydrocarbons such as methylene chloride, 1,2-dichloroethane, chloroform, and carbon tetrachloride are preferably used. The binder resin having a polyester skeleton including an aromatic group, highly-polar resin, colorant and release agent may be dissolved or dispersed together, however, typically they are independently dissolved or dispersed. The organic solvents may be different from each other, however, are preferably same in consideration of the solvent disposal afterwards.

A solution or a dispersion of the binder resin having a polyester skeleton including an aromatic group preferably has a resin concentration of from 40 to 80% by weight. When too high, the binder resin is difficult to dissolve or disperse in a solvent and has too high a viscosity to handle. When too low, the toner is not prepared much. When a modified polyester resin having an isocyanate group at the end of the binder resin having a polyester skeleton including an aromatic group is mixed therewith, they may be mixed in a same solution or a dispersion, or may be mixed after separately dissolved or dispersed. However, they are preferably mixed after separately dissolved or dispersed in consideration of their solubilities and viscosities.

The colorant may independently dissolved or dispersed, and may be mixed in the solution or dispersion of the polyester resin. In addition, a dispersion auxiliary or a polyester resin may optionally be added thereto, and the masterbatch may be used.

When a wax is dissolved or dispersed as a release agent, an organic solvent in which the wax is not dissolved is used as a dispersion liquid, and the dispersion liquid is prepared by a conventional method. Namely, an organic solvent and a wax are mixed to prepare a mixture, and the mixture may be dispersed by a disperser such as a beads mill. In addition, after an organic solvent and a wax are mixed to prepare a mixture, the mixture is heated to have a melting point of the wax and cooled while stirred, and then the mixture may be dispersed by a disperser such as a beads mill, which makes the dispersion time shorter. Further, plural kinds of waxes may be mixed therewith, and a dispersion auxiliary or a polyester resin may optionally be added thereto.

The aqueous medium for use in the present invention includes water alone and mixtures of water with a solvent which can be mixed with water. Further, the solvent having a Hansen solubility parameter not greater than 19.5 may be mixed therewith, and preferably added thereto in an amount close to a saturated amount thereof relative to water to increase emulsification or dispersibility of the oil phase. Specific examples of the solvent include alcohols such as methanol, isopropanol and ethylene glycol; dimethylformamide; tetrahydrofuran; cellosolves such as methyl cellosolve; and lower ketones such as acetone and methyl ethyl ketone. The aqueous medium is typically used in an amount of from 50 to 2,000 parts by weight per 100 parts by weight of the toner constituents, and preferably from 100 to 1,000 parts by weight. When less than 50 parts by weight, the dispersion of the toner constituents in the aqueous medium is not satisfactory, and thereby the resultant mother toner particles do not have a desired particle diameter. In contrast, when greater than 2,000, the production cost increases.

Before the toner constituents solution or dispersion is dispersed in the aqueous medium, an inorganic dispersant or an organic particulate resin is preferably dispersed therein because particle diameter distribution of the resultant toner becomes sharp and the toner constituents solution or dispersion is stably dispersed therein. Specific examples of the inorganic dispersant include tricalcium phosphate, calcium carbonate, titanium oxide, colloidal silica, hydroxyapatite, etc. Specific examples of the organic particulate resin include any thermoplastic and thermosetting resins such as vinyl resins, a polyurethane resin, an epoxy resin, a polyester resin, a polyamide resin, a polyimide resin, silicon resins, a phenol resin, a melamine resin, a urea resin, an aniline resin, an ionomer resin, a polycarbonate resin, etc. These resins can be used alone or in combination. Among these resins, the vinyl resins, the polyurethane resin, the epoxy resin, the polyester resin and their combinations are preferably used in terms of forming an aqueous dispersion of microscopic spherical particulate resins.

Methods of dispersing an organic particulate resin in an aqueous medium are not particularly limited, but include the following methods (a) to (h):

(a) polymerizing a vinyl monomer by a polymerization method such as a suspension polymerization method, an emulsion polymerization method, a seed polymerization method or a dispersion polymerization method to directly prepare an aqueous particulate resin dispersion;

(b) dispersing a precursor such as a monomer and an oligomer of polyaddition or polycondensated resins such as a polyester resin, a polyurethane resin and an epoxy resin or its solvent solution in an aqueous medium under the presence of a suitable dispersant to prepare a dispersion, and heating the dispersion and adding a hardener thereto to prepare an aqueous particulate resin dispersion;

(c) dissolving a suitable emulsifier in a precursor such as a monomer and an oligomer of polyaddition or polycondensated resins such as a polyester resin, a polyurethane resin and an epoxy resin or its solvent solution (preferably a liquid and may be heated to liquidate) to prepare a solution, and adding water thereto to phase-inversion emulsify;

(d) pulverizing a resin prepared by a polymerization reaction such as a addition polymerization reaction, a ring-opening polymerization reaction, polyaddition polymerization reaction, a addition condensation reaction and a condensation polymerization reaction with a pulverizer using a mechanical rotator or a jet to prepare a pulverized resin, classifying the pulverized resin to prepare a particulate resin, and dispersing the particulate resin in water under the presence of a suitable dispersant;

(e) dissolving a resin prepared by a polymerization reaction such as a addition polymerization reaction, a ring-opening polymerization reaction, polyaddition polymerization reaction, a addition condensation reaction and a condensation polymerization reaction in a solvent to prepare a resin solution, spraying the resin solution to prepare a particulate resin, and dispersing the particulate resin in water under the presence of a suitable dispersant;

(f) dissolving (while heating) a resin prepared by a polymerization reaction such as a addition polymerization reaction, a ring-opening polymerization reaction, polyaddition polymerization reaction, a addition condensation reaction and a condensation polymerization reaction in a solvent to prepare a resin solution, adding a solvent thereto (or cooling the resin solution) to separate out a particulate resin, removing the solvent from the particulate resin, and dispersing the particulate resin in water under the presence of a suitable dispersant;

(g) dissolving a resin prepared by a polymerization reaction such as a addition polymerization reaction, a ring-opening polymerization reaction, polyaddition polymerization reaction, a addition condensation reaction and a condensation polymerization reaction in a solvent to prepare a resin solution, dispersing the resin solution in an aqueous medium under the presence of a suitable dispersant to prepare a dispersion, and heating or depressurizing the dispersion to remove the solvent therefrom; and

(h) dissolving a resin prepared by a polymerization reaction such as a addition polymerization reaction, a ring-opening polymerization reaction, polyaddition polymerization reaction, a addition condensation reaction and a condensation polymerization reaction in a solvent to prepare a resin solution, dissolving a suitable emulsifier therein, and adding water thereto to phase-inversion emulsify.

Specific examples of the dispersants used to emulsify and disperse an oil phase for a liquid including water in which the toner constituents are dispersed include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group can prepare a dispersion having good dispersibility even when a small amount of the surfactant is used. Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4)sulfonate, sodium-{omega-fluoroalkanoyl(C6-C8)-N-ethylamino}-1-propane sulfonate, fluoroalkyl(C11-C20) carboxylic acids and their metal salts, perfluoroalkylcarboxylic acids and their metal salts, perfluoroalkyl (C4-C12) sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonylglycin, monoperfluoroalkyl(C6-C16)ethylphosphates, etc. Specific examples of the cationic surfactants, which can disperse an oil phase including toner constituents in water, include primary, secondary and tertiary aliphatic amines having a fluoroalkyl group, aliphatic quaternary ammonium salts such as erfluoroalkyl(C6-C10)sulfoneamidepropyltrimethylammonium salts, benzalkonium salts, benzetonium chloride, pyridinium salts, imidazolinium salts, etc.

Further, it is possible to stably disperse toner constituents in water using a polymeric protection colloid in combination with the inorganic dispersants and/or particulate polymers mentioned above. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid. When an acid such as calcium phosphate or a material soluble in alkaline is used as a dispersant, the calcium phosphate is dissolved with an acid such as a hydrochloric acid and washed with water to remove the calcium phosphate from a toner. Besides this method, it can also be removed by an enzymatic hydrolysis. When a dispersant is used, the dispersant may remain on the surface of a toner, but is preferably washed to remove in terms of the chargeability thereof.

The dispersion method is not particularly limited, and low speed shearing methods, high-speed shearing methods, friction methods, high-pressure jet methods, ultrasonic methods, etc. can be used. Among these methods, high-speed shearing methods are preferably used because particles having a particle diameter of from 2 to 20 μm can be easily prepared. At this point, the particle diameter (2 to 20 μm) means a particle diameter of particles including a liquid). When a high-speed shearing type dispersion machine is used, the rotation speed is not particularly limited, but the rotation speed is typically from 1,000 to 30,000 rpm, and preferably from 5,000 to 20,000 rpm. The temperature in the dispersion process is typically from 0 to 150° C. (under pressure), and preferably from 20 to 80° C.

Known methods can be used to remove an organic solvent from the emulsified dispersion. For example, a method of gradually heating the emulsified dispersion to completely evaporate the organic solvent therein can be used.

In order to prepare a modified polyester resin having a urethane and/or a urea group, when a modified polyester resin having an isocyanate group at the end and amines reactable therewith are added in an aqueous medium, the amines may be mixed in an oil phase before toner constituents are dispersed in the aqueous medium and may be added therein. The reaction time is dependent upon the isocyanate structure of the polyester prepolymer and the reactivity of the amines, and typically from 1 min to 40 hr, and preferably from 1 to 24 hr. The reaction temperature is typically from 0 to 150° C., and preferably from 20 to 98° C. This reaction may be performed before, during or after the process of adhering particulate material. In addition, a known catalyst can be used.

Known methods are used to wash and dry the toner particles dispersed in an aqueous medium.

Namely, subjecting the toner particles dispersed in an aqueous medium to a solid-liquid separation with a centrifugal separator or a filter press to prepare a toner cake; dispersing again the toner cake in ion-exchange water having a room temperature to 40° C. while controlling pH with an acid or an alkali when necessary; repeating subjecting the toner cake to a solid-liquid separation for several times to remove impurities or surfactant therefrom; and drying the toner cake with a drier such as a flash drier, a circulation drier, a decompression drier and a vibration fluidization drier to prepare a toner powder. Fine toner particles maybe removed therefrom with a centrifugal separator or the toner powder can have a desired particle diameter distribution with a known classifier when necessary.

Heterogeneous particles such as release agent particles, charge controlling particles, fluidizing particles and colorant particles can be mixed with a toner powder after dried. Release of the heterogeneous particles from composite particles can be prevented by giving a mechanical stress to a mixed powder to fix and fuse them on a surface of the composite particles.

Specific methods include a method of applying an impact strength on a mixture with a blade rotating at a high-speed, a method of putting a mixture in a high-speed stream and accelerating the mixture such that particles thereof collide each other or composite particles thereof collide with a collision board, etc. Specific examples of the apparatus include an ONG MILL from Hosokawa Micron Corp., a modified I-type mill having a lower pulverizing air pressure from Nippon Pneumatic Mfg. Co., Ltd., a hybridization system from Nara Machinery Co., Ltd., a Kryptron System from Kawasaki Heavy Industries, Ltd., an automatic mortar, etc.

The toner of the present invention is preferably used in the process cartridge of the present invention.

The process cartridge of the present invention includes at least an electrostatic latent image bearer and an image developer developing an electrostatic latent image formed on the electrostatic latent image bearer with the toner to be visible.

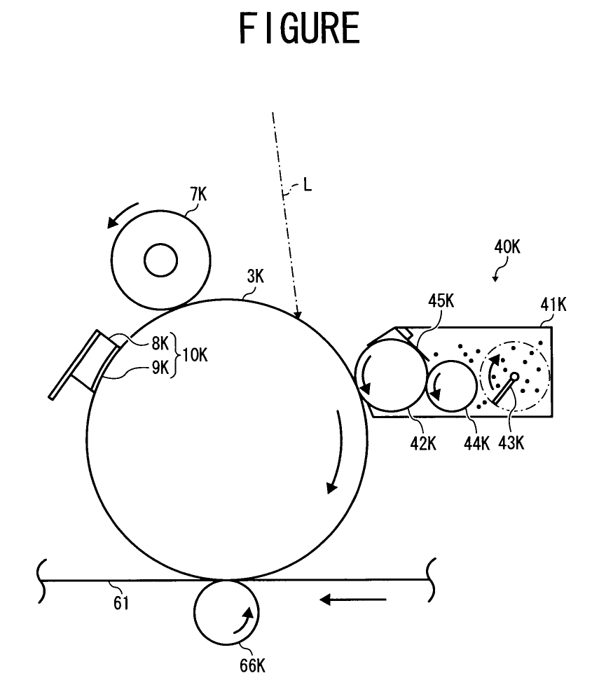

For example, the process cartridge in FIG. 1 can be used in an image forming apparatus.

The process cartridge in FIG. 1 includes an electrostatic latent image bearer 3K, a charger 7K, a charge applicator 10K for recharging a toner remaining on the surface of the electrostatic latent image bearer after transferred therefrom, an image developer 40K. The process cartridge is detachable from an image forming apparatus such as a copier and a printer.

The electrostatic latent image bearer 3K rotates at a predetermined circumferential speed. The circumferential surface of the electrostatic latent image bearer 3K is positively or negatively charged at a predetermined potential by the charger 7K while rotating, and irradiated with imagewise light L from an irradiator such as a slit irradiator and a laser beam scanning irradiator to form an electrostatic latent image on the surface of the electrostatic latent image bearer 3K. The electrostatic latent image is developed with a toner by the image developer 40K to form a toner image, and the toner image is transferred by a transferer 66K onto a transfer material 61 fed between the electrostatic latent image bearer 3K and the transferer 66K in synchronization with the rotation of the electrostatic latent image bearer from a paper feeder (not shown).

The transfer material 61 the toner image was transferred onto is separated from the surface of electrostatic latent image bearer, led to an image fixer where the toner image is fixed on the transfer material and printed out as a copy or a print.

After the toner image is transferred, a toner remaining on the surface of the electrostatic latent image bearer is recharged by the charge applicator 10K including an elastic member 8K and an electroconductive sheet 9K formed of an electroconductive material, and is collected in the developing process after passing the charger 7K to be repeatedly used for developing.

The image developer 40K has a developing roller 42K exposing a part of the circumferential surface thereof from an opening of a casing 41K. The developing roller 42K bearing a developer has a shaft projecting from both ends thereof in the longitudinal direction thereof, which is rotatably held by a bearing (not shown). The casing 41K includes a toner transferred by an agitator 43K from right to left in FIG. 1. On the left side of the agitator 43K in FIG. 1, a toner feed roller 44K rotated in anticlockwise direction by a driver (not shown) is located. The toner feed roller 44K has a roller formed of an elastic foam such as a sponge and catches the toner from the agitator 43K well. The toner caught thereby is fed to the developing roller 42K at a contact point between the toner feed roller 44K and the developing roller 42K. The thickness of the toner borne on the surface of the developing roller 42K is regulated by a regulation blade 45K and frictionally charged while the developing roller 42K rotates, and transferred to a developing area facing a photoreceptor 3K.

The charge applicator 10K for recharging a toner remaining on the surface of the electrostatic latent image bearer after transferred therefrom is preferably electroconductive because a toner adheres thereto due to charge-up if insulative.

The charge applicator is preferably a sheet formed of a member selected from the group consisting of nylon (polyamide resins), PTFE (polytetrafluoroethylene), PVDF (polyvinylidenefluoride) and urethane. Particularly, PTFE and PVDF are preferably used in terms of the chargeability of the toner.

The charge applicator preferably has a surface resistivity of from 10² to 10⁸ Ω/sq, and a volume resistivity of from 10¹ to 10⁶ Ω/sq. The charge applicator preferably has the shape of a roller, brush, sheet, etc., and more preferably has the shape of a sheet in consideration of the resettability of the toner.

The charge applicator is preferably applied with a voltage of from −1.4 to 0 kV in terms of charging the toner.

When the charge applicator is an electroconductive sheet, it preferably has a thickness of from 0.05 to 0.5 mm in terms of a contact pressure with the electrostatic latent image bearer. In addition, the charge applicator preferably has a nip width contacting the latent image bearer of from 1 to 10 mm in terms of charging the toner.

The toner analysis and evaluation were performed as follows. The toners were evaluated as a one-component developer, however, the toner of the present invention can be used as a two-component developer with a suitable external additive and a suitable carrier. The results are shown in Tables 1, 1-1 and 1-2.

### Particle Diameter

The average particle diameter and particle diameter distribution of the toner can be measured by a Coulter counter TA-II or Coulter Multisizer II from Beckman Coulter, Inc. as follows:

0.1 to 5 ml of a detergent, preferably alkylbenzene sulfonate is included as a dispersant in 100 to 150 ml of the electrolyte ISOTON R-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

An optical (detection) method is used to measure the shape, in which a suspension liquid including a toner particle is passed through a flat plate imaging (detector) and the toner particle image is optically detected by a CCD camera to analyze the image. A circumferential length of a circle having an area equivalent to that of a projected image obtained by the method is divided by an actual circumferential length of the particulate material to determine an average circularity.

### Average Circularity

A flow-type particle image analyzer FPIA-2000 from SYSMEX CORPORATION can measure the average circularity. A specific measuring method includes adding 0.1 to 0.5 ml of a surfactant, preferably an alkylbenzenesulfonic acid, as a dispersant in 100 to 150 ml of water from which impure solid materials are previously removed; adding 0.1 to 0.5 g of the toner in the mixture; dispersing the mixture including the toner with an ultrasonic disperser for 1 to 3 min to prepare a dispersion liquid having a concentration of from 3,000 to 10,000 pieces/μl; and measuring the toner shape and distribution with the above-mentioned measurer.

### Fluorine Strength

3.0 g of a sample is pressed by a molder having a diameter of 30 mm at a pressure of 6 Mpa for 1 min.

Measurement is performed using a wavelength-dispersive x-ray fluorescence spectrometer at a tube voltage of 50 KV, a tube current of 60 mA and a measurement angle of F-KA 74.74° for 40 sec. Analyzing crystals having a wavelength shorter than 2.88 nm (Mg to 0) were used.

### Background Fouling

Each predetermined 1,000 monochrome pattern images having an image ratio of 6% were continuously produced by IPSIO CX2500 from Ricoh Company, Ltd. in an environment of N/N (23° C. and 45% RH) and an environment of H/H (27° C. and 80% RH). A toner remaining on the photoreceptor was taped with a mending tape from Sumitomo 3M Ltd., and L [symbol] thereof was measured by spectrodensitometer X-rite 939 to classify into the following 4 grades. 85 or more has practically no problem.

⊚: 90 or more

◯: 85 to less than 90

Δ: 80 to less than 90

×: less than 80

### Smear Resistance

A halftone image having an image area of 60% and a toner adherence of 4.0±1 g/m² was formed on each of a recycle paper Shigen TYPE A from Ricoh Company, Ltd., having a smoothness of 34 s and a cotton paper, Gilbert Lancaster Bond paper, having a smoothness of 18 s, using a fixer of IPSIO CX2500 from Ricoh Company, Ltd. The images were fixed at 140° C. and 160° C. The fixed image is frictionized for 10 times with a white cotton cloth (JIS L0803 Cotton No. 3) using a clock meter, and the ID (hereinafter referred to as smear ID) of a taint on the cloth was measured by X-rite 939. 0.35 or more has practically no problem.

◯: less than 0.35

Δ: 0.35 to less than 0.55

×: 0.55 or more

### Fixability

A solid image having a toner adherence of 8.5±1 g/m² was formed on a TYPE 6200Y from Ricoh Company, Ltd., using a fixer of IPSIO CX2500 from Ricoh Company, Ltd. The images were fixed at 140° C. and 160° C. at a linear speed of 125 mm/sec and a nip width of 6 mm. A sapphire needle 125 μR was run on the solid image at a needle rotation diameter of 8 mm and a load of 1 g using a tracing tester AD-401 from Ueshima Seisakusho Co., Ltd. A scratch (trace) of the sapphire needle on the image was visually observed to evaluate the fixability. Δ or more has practically no problem.

◯: A trace is hardly observable

Δ: A trace is slightly observable but an underground paper is not exposed

×: A trace is clearly observable and an underground paper is exposed

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### <Synthesis of Polyester 1>

553 parts of an adduct of bisphenol A with 2 moles of ethyleneoxide, 196 parts of an adduct of bisphenol A with 2 moles of propyleneoxide, 220 parts terephthalic acid, 45 parts of adipic acid and 2 parts of dibutyltinoxide were polycondensated in a reactor vessel including a cooling pipe, a stirrer and a nitrogen inlet pipe for 8 hrs at a normal pressure and 230° C. Further, after the mixture was depressurized to 10 to 15 mm Hg and reacted for 5 hrs, 46 parts of trimellitic acid anhydride were added thereto and the mixture was reacted for 2 hrs at a normal pressure and 180° C. to prepare a [polyester 1]. The [polyester 1] had a number-average molecular weight of 2,200, a weight-average molecular weight of 5,600, a glass transition temperature (Tg) of 43° C. and an acid value of 13.

### <Synthesis of Prepolymer 1>

682 parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen inlet pipe for 8 hrs at a normal pressure and 230° C. Further, after the mixture was depressurized to 10 to 15 mm Hg and reacted for 5 hrs to prepare an [intermediate polyester 1]. The [intermediate polyester 1] had a number-average molecular weight of 2,100, a weight-average molecular weight of 9,500, a Tg of 55° C. and an acid value of 0.5 and a hydroxyl value of 49.

Next, 411 parts of the [intermediate polyester 1], 89 parts of isophoronediisocyanate and 500 parts of ethyl acetate were reacted in a reactor vessel including a cooling pipe, a stirrer and a nitrogen inlet pipe for 5 hrs at 100° C. to prepare a [prepolymer 1]. The [prepolymer 1] included a free isocyanate in an amount of 1.53% by weight.

### <Synthesis of Masterbatch 1>

40 parts of carbon black REGAL 400R from Cabot Corp., 60 parts of a binder resin, i.e., a polyester resin RS-801 having an acid value of 10, a Mw of 20,000 and a Tg of 64° C. and 30 parts of water were mixed by a HENSCHEL mixer to prepare a water-logged pigment agglomerate. This was kneaded by a two-roll mil having a surface temperature of 130° C. for 45 min, extended upon application of pressure, cooled and pulverized by a pulverizer to prepare a [masterbacth 1] having a particle diameter of 1 mm.

### Example 1

### <Preparation of Pigment and Wax Dispersion 1>

378 parts of the [polyester 1], 120 parts of paraffin wax (HNP9), 96 parts of a release agent (wax) dispersant (styrene-polyethylene polymer having a Tg of 73° C., a number-average molecular weight of 7,100 and a release agent ratio of 80% and 1450 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the [masterbacth 1] and 500 parts of ethyl acetate were added to the mixture and mixed for 1 hr to prepare a [material solution 1].

1,500 parts of the material solution were transferred into another vessel, and the carbon black and wax therein were dispersed by a beads mill (Ultra Visco Mill from IMECS CO., LTD.) for 3 passes at a liquid feeding speed of 1 kg/hr and a peripheral disc speed of 6 m/sec using zirconia beads having diameter of 0.5 mm for 80% by volume to prepare a wax dispersion. Next, 655 parts of an ethyl acetate solution of the [polyester 1] having a concentration of 65% were added to the wax dispersion and the mixture was stirred by the beads mill for one pass to prepare a [pigment and wax dispersion 1] at 130° C. for 30 min to have a solid content concentration of 50%.

### <Preparation of Aqueous Phase 1>

953 parts of ion-exchange water, 88 parts of an aqueous dispersion including an organic particulate resin a copolymer of styrene-methacrylic acid-butylacrylate-sodium salt of sulfate of ethylene oxide adduct of methacrylic acid in an mount of 25% by weight, 90 parts of an aqueous solution of sodium dodecyldiphenyletherdisulfonate having a concentration of 48.5% (ELEMINOL MON-7 from Sanyo Chemical Industries, Ltd.) and 113 parts of ethyl acetate were mixed and stirred to prepare a lacteous liquid, i.e., an [aqueous phase 1].

### <Emulsification Process>

967 parts of the pigment and wax dispersion liquid 1, 0.2% by weight (based on total weight of the toner constituents or based on the total weight of the final non-magnetic toner) of the layered inorganic mineral shown in Table 1 and 6 parts of isophoronediamine were mixed in a vessel by a TK-type homomixer from Tokushu Kika Kogyo Co., Ltd. at 5,000 rpm for 1 min. Then, 137 parts of the [prepolymer 1] were added to the mixture and mixed therewith by the TK-type homomixer at 5,000 rpm for 1 min. Then, 1,200 parts of the [aqueous phase 1] were added to the mixture and mixed by the TK-type homomixer at from 8,000 to 13,000 rpm for 20 min to prepare an [emulsified slurry 1].

### <De-solvent>

The [emulsified slurry 1] was put in a vessel including a stirrer and a thermometer, a solvent was removed therefrom at 30° C. for 8 hrs to prepare a [dispersion slurry 1].

### <Washing and Drying>

(1) After the [dispersion slurry 1] was filtered under reduced pressure to prepare a filtered cake, 100 parts of ion-exchange water were added to the filtered cake and mixed by the TK-type homomixer at 12,000 rpm for 10 min, and the mixture was filtered.

(2) Further, 900 parts of ion-exchange water were added to the filtered cake and mixed by the TK-type homomixer at 12,000 rpm for 30 min upon application of ultrasonic vibration, and the mixture was filtered under reduced pressure. This ultrasonic alkaline washing was repeated until the slurry has a conductivity not greater than 10 μC/cm.

(3) Further, hydrochloric acid having a concentration of 10% was added to the filtered cake and mixed by the TK-type homomixer at 12,000 rpm for 30 min until the slurry has a pH of 4.

(4) Further, 100 parts of ion-exchange water were added to the filtered cake and mixed by the TK-type homomixer at 12,000 rpm for 10 min, and the mixture was filtered. This operation was repeated until the slurry has a conductivity not greater than 10 μC/cm to prepare a [filtered cake 1].

An aqueous solution of N,N,N,-trimethyl-[3-(4-perfluorononenyloxybenzamide)propyl] ammonium iodide (product name FUTARGENT 310 from Neos Co., Ltd.) having the formula (1) and a concentration of 1% by weight was gradually added to the [filtered cake 1] while stirred to have 0.2% by weight based on the total weight of the final non-magnetic toner. Then, the [filtered cake 1] was stirred at a room temperature for 1 hr., filtered and separated, and dried under reduced pressure at 40° C. for 24 hrs to prepare toner particles 1.

The toner particles 1 were sieved by a mesh having an opening of 75 μm to prepare a [parent toner 1]. The [parent toner 1] had a volume-average particle diameter (Dv) of 6.5 μm, a number-average particle diameter (Dp) of 5.4 μm and Dv/Dp of 1.12 and an average circularity of 0.953. 100 parts of the [parent toner 1], 1.5 parts of hydrophobic silica H2000/4 having a particle diameter of 12 nm from Clariant (Japan) K.K. and 0.5 parts of hydrophobic silica RX50 having a particle diameter of 40 nm from Nippon Aerosil Co., Ltd. were mixed in HENSCHEL mixer to prepare a [developer 1] of the present invention.

### Examples 2 to 5

The procedure for preparation of the developer 1 was repeated to prepare developers of Examples 2 to 5 except for changing the amounts of formula of the layered inorganic mineral and fluorine-containing compound as shown in Table 1.

### Comparative Examples 1 to 8

The procedure for preparation of the developer 1 was repeated to prepare developers of Comparative Examples 1 to 8 except for changing the amounts of formula of the layered inorganic mineral and fluorine-containing compound as shown in Table 1.

TABLE 1

| | Toner Composition | | | |
|---|---|---|---|---|
| | Layered Inorganic | | Fluorine-containing | |
| | Mineral | | Compound | |
| | | % | | % |
| | | by weight | | by weight |
| Example 1 | ClaytonAPA | 1 | FUTARGENT 310 | 0.2 |
| Example 2 | ClaytonAPA | 1.5 | FUTARGENT 310 | 0.2 |
| Example 3 | ClaytonAPA | 0.1 | FUTARGENT 310 | 0.2 |
| Example 4 | ClaytonAPA | 1 | FUTARGENT 310 | 0.05 |
| Example 5 | ClaytonAPA | 1 | FUTARGENT 310 | 0.4 |
| Comparative | ClaytonAPA | 1 | FUTARGENT 310 | 0.6 |
| Example 1 | | | | |
| Comparative | ClaytonAPA | 3 | FUTARGENT 310 | 0.2 |
| Example 2 | | | | |
| Comparative | Kunipia | 1 | FUTARGENT 310 | 0.2 |
| Example 3 | | | | |
| Comparative | ClaytonAPA | 1 | FUTARGENT 150 | 0.2 |
| Example 4 | | | | |
| Comparative | Kunipia | 1 | FUTARGENT 150 | 0.2 |
| Example 5 | | | | |
| Comparative | ClaytonAPA | 1 | None | 0 |
| Example 6 | | | | |
| Comparative | None | 0 | FUTARGENT 310 | 0.2 |
| Example 7 | | | | |
| Comparative | None | 0 | None | 0 |
| Example 8 | | | | |

Clayton APA from Southern Clay products, Inc.: quaternary alkylammonium salt modified layered inorganic compound
Kunipia from KUNIMINE INDUSTRIES CO., LTD.
FUTARGENT 310 from Neos Co., Ltd.: fluoroalkylammonium salt compound (N,N,N,-trimethyl-[3-(4-perfluorononenyloxybenzamide)propyl]ammonium iodide)
FUTARGENT 150 from Neos Co., Ltd.: fluoroalkyl sodiumcarbonate compound

TABLE 1-1

| Evaluation Result | | |
|---|---|---|
| Initial | | |
| F | 23° C.55% RH | 27° C.80% RH |

| | K cps | L* | | L* | |
|---|---|---|---|---|---|
| Example 1 | 0.04 | 92 | ⊚ | 92 | ⊚ |
| Example 2 | 0.039 | 92 | ⊚ | 88 | ◯ |
| Example 3 | 0.039 | 92 | ⊚ | 90 | ⊚ |
| Example 4 | 0.021 | 90 | ⊚ | 88 | ◯ |
| Example 5 | 0.064 | 92 | ⊚ | 92 | ⊚ |
| Comparative | 0.085 | 92 | ⊚ | 92 | ⊚ |
| Example 1 | | | | | |
| Comparative | 0.039 | 92 | ⊚ | 76 | X |
| Example 2 | | | | | |
| Comparative | 0.041 | 91 | ⊚ | 84 | Δ |
| Example 3 | | | | | |
| Comparative | 0.038 | 91 | ⊚ | 90 | ⊚ |
| Example 4 | | | | | |
| Comparative | 0.039 | 91 | ⊚ | 84 | Δ |
| Example 5 | | | | | |
| Comparative | 0 | 86 | ◯ | 84 | Δ |
| Example 6 | | | | | |
| Comparative | 0.042 | 89 | ◯ | 85 | Δ |
| Example 7 | | | | | |
| Comparative | 0 | 70 | X | 62 | X |
| Example 8 | | | | | |

TABLE 1-2

| | Evaluation Result | | | | | | |
|---|---|---|---|---|---|---|---|
| | | | | | | Fixablity | |
| | After 1,000 | | | | | Smear | |
| | F | 23° C.55% RH | | 27° C.80% RH | | resistance | |
| | K cps | L* | | L* | | ID | |
| Example 1 | 0.04 | 91 | ⊚ | 90 | ⊚ | 0.27 | ◯ |
| Example 2 | 0.038 | 90 | ⊚ | 86 | ◯ | 0.27 | ◯ |
| Example 3 | 0.036 | 89 | ◯ | 86 | ◯ | 0.26 | ◯ |
| Example 4 | 0.021 | 87 | ◯ | 86 | ◯ | 0.21 | ◯ |
| Example 5 | 0.063 | 91 | ⊚ | 91 | ⊚ | 0.39 | Δ |
| Comparative | 0.083 | 92 | ⊚ | 91 | ⊚ | 0.58 | X |
| Example 1 | | | | | | | |
| Comparative | 0.039 | 91 | ⊚ | 72 | X | 0.28 | ◯ |
| Example 2 | | | | | | | |
| Comparative | 0.02 | 72 | X | 65 | X | 0.27 | ◯ |
| Example 3 | | | | | | | |
| Comparative | 0.023 | 72 | X | 66 | X | 0.26 | ◯ |
| Example 4 | | | | | | | |
| Comparative | 0.021 | 72 | X | 60 | X | 0.27 | ◯ |
| Example 5 | | | | | | | |
| Comparative | 0 | 70 | X | 63 | X | 0.14 | ◯ |
| Example 6 | | | | | | | |
| Comparative | 0.018 | 71 | X | 65 | X | 0.29 | ◯ |
| Example 7 | | | | | | | |
| Comparative | 0 | 66 | X | 60 | X | 0.15 | ◯ |
| Example 8 | | | | | | | |

### <Synthesis of Polyester 2>

553 parts of an adduct of bisphenol A with 2 moles of ethyleneoxide, 196 parts of an adduct of bisphenol A with 2 moles of propyleneoxide, 220 parts terephthalic acid, 45 parts of adipic acid and 2 parts of dibutyltinoxide were polycondensated in a reactor vessel including a cooling pipe, a stirrer and a nitrogen inlet pipe for 8 hrs at a normal pressure and 230° C. Further, after the mixture was depressurized to 10 to 15 mm Hg and reacted for 5 hrs, 46 parts of trimellitic acid anhydride were added thereto and the mixture was reacted for 2 hrs at a normal pressure and 180° C. to prepare a [polyester 2]. The [polyester 2] had a number-average molecular weight of 2,100, a weight-average molecular weight of 5,600, a glass transition temperature (Tg) of 44° C. and an acid value of 12.

### <Synthesis of Prepolymer 2>

682 parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen inlet pipe for 8 hrs at a normal pressure and 230° C. Further, after the mixture was depressurized to 10 to 15 mm Hg and reacted for 5 hrs to prepare an [intermediate polyester 2]. The [intermediate polyester 2] had a number-average molecular weight of 2,000, a weight-average molecular weight of 9,600, a Tg of 56° C. and an acid value of 0.5 and a hydroxyl value of 49.

Next, 411 parts of the [intermediate polyester 2], 89 parts of isophoronediisocyanate and 500 parts of ethyl acetate were reacted in a reactor vessel including a cooling pipe, a stirrer and a nitrogen inlet pipe for 5 hrs at 100° C. to prepare a [prepolymer 2]. The [prepolymer 2] included a free isocyanate in an amount of 1.52% by weight.

### <Synthesis of Masterbatch 2>

40 parts of carbon Pigment Blue 15:3, 60 parts of a binder resin, i.e., a polyester resin RS-801 having an acid value of 10, a Mw of 20,000 and a Tg of 64° C. and 30 parts of water were mixed by a HENSCHEL mixer to prepare a water-logged pigment agglomerate. This was kneaded by a two-roll mil having a surface temperature of 130° C. for 45 min, extended upon application of pressure, cooled and pulverized by a pulverizer to prepare a [masterbacth 2] having a particle diameter of 1 mm.

### Example 6

### <Preparation of Pigment and Wax Dispersion 2>

(1) 378 parts of the [polyester 2], 120 parts of paraffin wax (HNP9), 96 parts of a release agent (wax) dispersant (styrene-polyethylene polymer having a Tg of 73° C., a number-average molecular weight of 7,100 and a release agent ratio of 80% and 1450 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour.

(2) Then, 500 parts of the [masterbacth 2] and 500 parts of ethyl acetate were added to the mixture and mixed for 1 hr to prepare a [material solution 2].

(3) 1,500 parts of the material solution were transferred into another vessel, and the carbon black and wax therein were dispersed by a beads mill (Ultra Visco Mill from IMECS CO., LTD.) for 3 passes at a liquid feeding speed of 1 kg/hr and a peripheral disc speed of 6 m/sec using zirconia beads having diameter of 0.5 mm for 80% by volume to prepare a wax dispersion.

(4) Next, 655 parts of an ethyl acetate solution of the [polyester 2] having a concentration of 65% were added to (3) and the mixture was stirred by the beads mill for one pass to prepare a [pigment and wax dispersion 2].

(5) Ethyl acetate was added to the (4) [pigment and wax dispersion 2] at 130° C. for 30 min to have a solid content concentration of 50%.

### <Preparation of Aqueous Phase 2>

953 parts of ion-exchange water, 88 parts of an aqueous dispersion including an organic particulate resin a copolymer of styrene-methacrylic acid-butylacrylate-sodium salt of sulfate of ethylene oxide adduct of methacrylic acid in an mount of 25% by weight, 90 parts of an aqueous solution of sodium dodecyldiphenyletherdisulfonate having a concentration of 48.5% (ELEMINOL MON-7 from Sanyo Chemical Industries, Ltd.) and 113 parts of ethyl acetate were mixed and stirred to prepare a lacteous liquid, i.e., an [aqueous phase 2].

### <Emulsification Process>

(1) 967 parts of the pigment and wax dispersion liquid 1, 0.2% by weight (based on total weight of the toner constituents or based on the total weight of the final non-magnetic toner) of the layered inorganic mineral shown in Table 1 and 6 parts of isophoronediamine were mixed in a vessel by a TK-type homomixer from Tokushu Kika Kogyo Co., Ltd. at 5,000 rpm for 1 min.

(2) Then, 137 parts of the [prepolymer 2] were added to the mixture and mixed therewith by the TK-type homomixer at 5,000 rpm for 1 min.

(3) Then, 1,200 parts of the [aqueous phase 2] were added to the mixture and mixed by the TK-type homomixer at from 8,000 to 13,000 rpm for 20 min to prepare an [emulsified slurry 2].

### <De-Solvent>

The [emulsified slurry 2] was put in a vessel including a stirrer and a thermometer, a solvent was removed therefrom at 30° C. for 8 hrs to prepare a [dispersion slurry 2].

### <Washing and Drying>

(1) After the [dispersion slurry 2] was filtered under reduced pressure to prepare a filtered cake, 100 parts of ion-exchange water were added to the filtered cake and mixed by the TK-type homomixer at 12,000 rpm for 10 min, and the mixture was filtered.

(2) Further, 900 parts of ion-exchange water were added to the filtered cake and mixed by the TK-type homomixer at 12,000 rpm for 30 min upon application of ultrasonic vibration, and the mixture was filtered under reduced pressure. This ultrasonic alkaline washing was repeated until the slurry has a conductivity not greater than 10 μC/cm.

(3) Further, hydrochloric acid having a concentration of 10% was added to the filtered cake and mixed by the TK-type homomixer at 12,000 rpm for 30 min until the slurry has a pH of 4.

(4) Further, 100 parts of ion-exchange water were added to the filtered cake and mixed by the TK-type homomixer at 12,000 rpm for 10 min, and the mixture was filtered. This operation was repeated until the slurry has a conductivity not greater than 10 μC/cm to prepare a [filtered cake 2].

An aqueous solution of N,N,N,-trimethyl-[3-(4-perfluorononenyloxybenzamide)propyl] ammonium iodide (product name FUTARGENT 310 from Neos Co., Ltd.) having the formula (1) and a concentration of 1% by weight was gradually added to the [filtered cake 2] while stirred to have 0.2% by weight based on the total weight of the final non-magnetic toner. Then, the [filtered cake 2] was stirred at a room temperature for 1 hr., filtered and separated, and dried under reduced pressure at 40° C. for 24 hrs to prepare toner particles 2.

The toner particles 1 were sieved by a mesh having an opening of 75 μm to prepare a [parent cyan toner 1]. The [parent cyan toner 1] had a volume-average particle diameter (Dv) of 5.8 μm, a number-average particle diameter (Dp) of 5.2 μm and Dv/Dp of 1.12 and an average circularity of 0.953. 100 parts of the [parent toner 1], 1.5 parts of hydrophobic silica H2000/4 having a particle diameter of 12 nm from Clariant (Japan) K.K. and 0.5 parts of hydrophobic silica RX50 having a particle diameter of 40 nm from Nippon Aerosil Co., Ltd. were mixed in HENSCHEL mixer to prepare a [developer 6] of the present invention.

### Examples 7 to 10

The procedure for preparation of the developer 6 was repeated to prepare developers of Examples 7 to 10 except for changing the amounts of formula of the layered inorganic mineral and fluorine-containing compound as shown in Table 2.

### Comparative Examples 9 to 16

The procedure for preparation of the developer 6 was repeated to prepare developers of Comparative Examples 9 to 16 except for changing the amounts of formula of the layered inorganic mineral and fluorine-containing compound as shown in Table 2.

TABLE 2

| | Toner Composition | | | |
|---|---|---|---|---|
| | Layered Inorganic | | Fluorine-containing | |
| | Mineral | | Compound | |
| | | % | | % |
| | | by weight | | by weight |
| Example 6 | ClaytonAPA | 1 | FUTARGENT 310 | 0.2 |
| Example 7 | ClaytonAPA | 2 | FUTARGENT 310 | 0.2 |
| Example 8 | ClaytonAPA | 0.05 | FUTARGENT 310 | 0.2 |
| Example 9 | ClaytonAPA | 1 | FUTARGENT 310 | 0.05 |
| Example 10 | ClaytonAPA | 1 | FUTARGENT 310 | 0.5 |
| Comparative | ClaytonAPA | 1 | FUTARGENT 310 | 0.6 |
| Example 9 | | | | |
| Comparative | ClaytonAPA | 1 | None | 0 |
| Example 10 | | | | |
| Comparative | ClaytonAPA | 3 | FUTARGENT 310 | 0.2 |
| Example 11 | | | | |
| Comparative | None | 0 | FUTARGENT 310 | 0.2 |
| Example 12 | | | | |
| Comparative | ClaytonAPA | 1 | FUTARGENT 150 | 0.2 |
| Example 13 | | | | |
| Comparative | Kunipia | 1 | FUTARGENT 310 | 0.2 |
| Example 14 | | | | |
| Comparative | Kunipia | 1 | FUTARGENT 150 | 0.2 |
| Example 15 | | | | |
| Comparative | None | 0 | None | 0 |
| Example 16 | | | | |

The evaluation results on the background fouling and fixability of each of the developers prepared in Examples 6 to 10 and Comparative Examples 9 to 16 are shown in Tables 3-1 and 3-2.

TABLE 3-1

| Evaluation Result | | |
|---|---|---|
| Initial | | |
| F | 23° C.55% RH | 27° C.80% RH |

| | K cps | L* | | L* | |
|---|---|---|---|---|---|
| Example 6 | 0.04 | 92 | ⊚ | 92 | ⊚ |
| Example 7 | 0.039 | 92 | ⊚ | 87 | ◯ |
| Example 8 | 0.039 | 92 | ⊚ | 90 | ⊚ |
| Example 9 | 0.021 | 90 | ⊚ | 88 | ◯ |
| Example 10 | 0.074 | 92 | ⊚ | 92 | ⊚ |
| Comparative | 0.085 | 92 | ⊚ | 92 | ⊚ |
| Example 9 | | | | | |
| Comparative | 0 | 86 | ◯ | 84 | Δ |
| Example 10 | | | | | |
| Comparative | 0.039 | 92 | ⊚ | 76 | X |
| Example 11 | | | | | |
| Comparative | 0.042 | 89 | ◯ | 85 | Δ |
| Example 12 | | | | | |
| Comparative | 0.038 | 91 | ⊚ | 90 | ⊚ |
| Example 13 | | | | | |
| Comparative | 0.041 | 91 | ⊚ | 84 | Δ |
| Example 14 | | | | | |
| Comparative | 0.039 | 91 | ⊚ | 84 | Δ |
| Example 15 | | | | | |
| Comparative | 0 | 70 | X | 62 | X |
| Example 16 | | | | | |

TABLE 3-2

| | Evaluation Result | | | | | |
|---|---|---|---|---|---|---|
| | After 1,000 | | | | | |
| | F | 23° C.55% RH | | 27° C.80% RH | | |
| | K cps | L* | | L* | | Fixablity |
| Example 6 | 0.04 | 91 | ⊚ | 90 | ⊚ | ◯ |
| Example 7 | 0.038 | 90 | ⊚ | 85 | ◯ | ◯ |
| Example 8 | 0.036 | 89 | ◯ | 89 | ◯ | ◯ |
| Example 9 | 0.021 | 87 | ◯ | 86 | ◯ | ◯ |
| Example 10 | 0.073 | 91 | ⊚ | 91 | ⊚ | Δ |
| Comparative | 0.083 | 92 | ⊚ | 91 | ⊚ | X |
| Example 9 | | | | | | |
| Comparative | 0 | 70 | X | 63 | X | ◯ |
| Example 10 | | | | | | |
| Comparative | 0.039 | 91 | ⊚ | 72 | X | ◯ |
| Example 11 | | | | | | |
| Comparative | 0.018 | 71 | X | 65 | X | ◯ |
| Example 12 | | | | | | |
| Comparative | 0.016 | 72 | X | 66 | X | ◯ |
| Example 13 | | | | | | |
| Comparative | 0.012 | 72 | X | 65 | X | ◯ |
| Example 14 | | | | | | |
| Comparative | 0.01 | 72 | X | 60 | X | ◯ |
| Example 15 | | | | | | |
| Comparative | 0 | 66 | X | 60 | X | ◯ |
| Example 16 | | | | | | |

This application claims priority and contains subject matter related to Japanese Patent Application No. 2007-066101 filed on Mar. 15, 2007, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising a fluorine-containing compound partially comprising a quaternary ammonium group at the surface thereof, which is prepared by a method, comprising:
dispersing or emulsifying an oil phase comprising toner constituents comprising a pigment, and at least one member selected from the group consisting of modified layered inorganic minerals partially comprising a quaternary alkylammonium group and toner constituent precursors in an aqueous medium,
wherein the toner constituents comprises the modified layered inorganic mineral in an amount of from 0.05 to 2% by weight and the toner comprises a fluorine atom in an amount of from 0.02 to 0.075 K cps when measured with a fluorescent X-ray.

2. The toner of claim 1, wherein the modified layered inorganic mineral is a member selected from the group consisting of modified montmorillonite, modified bentonite, modified hectolite, modified attapulgite and modified sepiolite.

3. The toner of claim 1, wherein the modified layered inorganic mineral includes ions between layers thereof, at least a part of which is modified with a quaternary alkylammonium salt.

4. The toner of claim 1, wherein the fluorine-containing compound has the following formula (1): 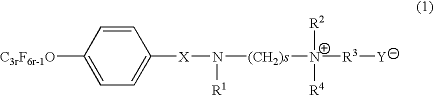
wherein X represents —SO₂— or —CO—; R¹ to R⁴ independently represent a hydrogen atom, a lower alkyl group having 1 to 10 carbon atoms or an aryl group; Y represents I or Br; and r and s independently represents an integer of from 1 to 20.

5. The toner of claim 1, wherein the toner is anon-magnetic toner for use in a non-magnetic one-component developer.

6. A process cartridge detachable from an image forming apparatus, comprising:
an electrostatic latent image bearer configured to bear an electrostatic latent image; and
an image developer configured to develop the electrostatic latent image with a toner to form a visible image,
wherein the toner comprises a fluorine-containing compound partially comprising a quaternary ammonium group at the surface thereof, which is prepared by a method, comprising:
dispersing or emulsifying an oil phase comprising toner constituents comprising a pigment, and at least one member selected from the group consisting of modified layered inorganic minerals partially comprising a quaternary alkylammonium group and toner constituent precursors in an aqueous medium,
wherein the toner constituents comprises the modified layered inorganic mineral in an amount of from 0.05 to 2% by weight and the toner comprises a fluorine atom in an amount of from 0.02 to 0.075 K cps when measured with a fluorescent X-ray.

7. The process cartridge of claim 6, wherein the modified layered inorganic mineral is a member selected from the group consisting of modified montmorillonite, modified bentonite, modified hectolite, modified attapulgite and modified sepiolite.

8. The process cartridge of claim 6, wherein the modified layered inorganic mineral includes ions between layers thereof, at least a part of which is modified with a quaternary alkylammonium salt.

9. The process cartridge of claim 6, wherein the fluorine-containing compound has the following formula (1): 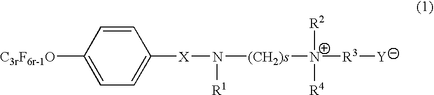
wherein X represents —SO₂— or —CO—; R¹ to R⁴ independently represent a hydrogen atom, a lower alkyl group having 1 to 10 carbon atoms or an aryl group; Y represents I or Br; and r and s independently represents an integer of from 1 to 20.

10. The process cartridge of claim 6, wherein the toner is a non-magnetic toner for use in a non-magnetic one-component developer.
